(19) United States
(12) Patent Application Publication
(10) Pub. No.: US 2025/0110814 A1
(43) Pub. Date: Apr. 3, 2025

(54) SIGNAL AGGREGATION

(71) Applicant: Apple Inc., Cupertino, CA (US)

(72) Inventors: Neven KLACAR, San Diego, CA (US); Derek IWAMOTO, Sunnyvale, CA (US); Patrick S. HARPER, Oceanside, CA (US); Jian LI, San Jose, CA (US)

(21) Appl. No.: 18/641,173

(22) Filed: Apr. 19, 2024

Related U.S. Application Data
(60) Provisional application No. 63/586,124, filed on Sep. 28, 2023.

(51) Int. Cl. G06F 9/54; G06F 9/50; G06F 13/28

(52) U.S. Cl. CPC G06F 9/546; G06F 9/5038; G06F 13/28

(57) ABSTRACT

A system for aggregating signals for sensors in a computer system is disclosed. Multiple aggregator circuits are coupled to corresponding sets of sensors. A particular client of multiple clients in the computer system may generate a request for a particular sensor and send the request to an aggregation processor coupled to multiple clients. The aggregation processor can relay the request to a particular aggregator circuit coupled to the particular sensor. Upon receiving the request, the particular aggregator circuit may relay the request to the particular sensor.

### CROSS-REFERENCE TO RELATED APPLICATIONS

The present application claims the benefit of U.S. Provisional Application No. 63/586,124, entitled “SIGNAL AGGREGATION,” filed Sep. 28, 2023, the content of which is incorporated by reference herein in its entirety for all purposes.

### FIELD

The described embodiments relate generally to computer systems and, more particularly, to techniques for aggregating signals received by a system-on-a-chip.

### BACKGROUND

Modern computer systems may include multiple circuit blocks designed to perform various functions. For example, such circuit blocks may include processors or processor cores configured to execute software or program instructions. Additionally, the circuit blocks may include memory circuits, mixed-signal circuits, analog circuits, and the like.

In addition to circuit blocks, some computer systems can also include sensors. Such sensors can be used to monitor acceleration, battery charge level, location via a global positioning system (GPS), ambient light, and the like. In many cases, sensors generate data that can be processed by processor or controller circuits. In some cases, sensors can generate an interrupt or other alert signal in response to the detection of a particular event.

### BRIEF DESCRIPTION OF THE DRAWINGS

FIG. 1 is a block diagram depicting an embodiment of a computer system that uses signal aggregation.

FIG. 2 is a block diagram depicting an embodiment of an aggregation processor.

FIG. 3 is a block diagram depicting an embodiment of communication between a client and an aggregation processor.

FIG. 4 is a block diagram depicting an embodiment of an aggregator circuit.

FIG. 5 is a block diagram depicting an embodiment of an address map for an aggregator circuit.

FIG. 6 is a block diagram depicting an embodiment of a computer system that uses security checks and signal aggregation.

FIG. 7 is a block diagram depicting an embodiment of a computer system where an aggregation processor can offload tasks from a client.

FIG. 8 is a block diagram depicting an embodiment of a computer system that timestamps events.

FIG. 9 is a diagram depicting two circuit blocks synchronizing their respective time bases.

FIG. 10 is a flow diagram depicting an embodiment of a method for operating a computer system that uses signal aggregation.

FIG. 11 is a flow diagram depicting an embodiment of a method for processing interrupts in a computer system that uses signal aggregation.

FIG. 12 is a flow diagram depicting an embodiment of a method for synchronizing time bases between an aggregation processor and an aggregator circuit.

FIG. 13 is a flow diagram depicting an embodiment of a method for using security checks in a computer system that uses signal aggregation.

FIG. 14 is a flow diagram depicting an embodiment of a method for offloading processing tasks from a client in a computer system that uses signal aggregation.

FIG. 15 is a flow diagram depicting an embodiment of a method for timestamping events in a computer system that uses signal aggregation.

FIG. 16 is a flow diagram depicting an embodiment of a method for synchronizing time bases between two different circuit blocks.

FIG. 17 is a block diagram of an embodiment of a device that includes aggregator circuits.

FIG. 18 is a block diagram of various embodiments of computer systems that may include power management circuits.

FIG. 19 illustrates an example of a non-transitory computer-readable storage medium that stores circuit design information.

### DETAILED DESCRIPTION

Computer systems may include multiple circuit blocks configured to perform specific functions. In some cases, computer systems may also include multiple sensors which can be configured to collect data on various environmental parameters associated with a given computer system. For example, a sensor may measure ambient light in the location of the computer system.

Data from sensors may be processed and used to adjust operating parameters of the computer system. For example, in response to a change in ambient light, the brightness of a display coupled to the computer system may be adjusted. Alternatively, a sensor may monitor a charge level of a battery coupled to the computer system. In response to a determination that the charge level is below a threshold level, a message may be generated to indicate the battery needs to be recharged.

To process data from sensors in a computer system, the data may be relayed to a central processing circuit. In some cases, such a central processing circuit may be implemented as a system-on-a-chip (or “SoC”) that includes dedicated circuits (referred to as “clients”) configured to process data from a corresponding sensor.

Data may be exchanged between clients and their corresponding sensors using various communication protocols (e.g., I2C). In order to support the communication between clients and their corresponding sensors, additional pins need to be added to an SoC. Such additional pins can add to the overall silicon area of the SoC, which can increase the cost to manufacture the SoC, as well as increase the probability of developing a defect during manufacture of the SoC.

The embodiments illustrated in the drawings and described below provide techniques for combining (or “aggregating”) signals from multiple sensors. To aggregate sensor signals, one or more aggregator circuits collect respective communication signals from corresponding sensors and relay the communication signals to a central processing circuit. The central processing circuit includes a processor circuit relays the communication signals to one or more clients coupled to the central processing unit. By aggregating signals to/from sensors in a computer system, the pin count of the central processing circuit can be reduced, thereby reducing manufacturing cost of the central processing circuit.

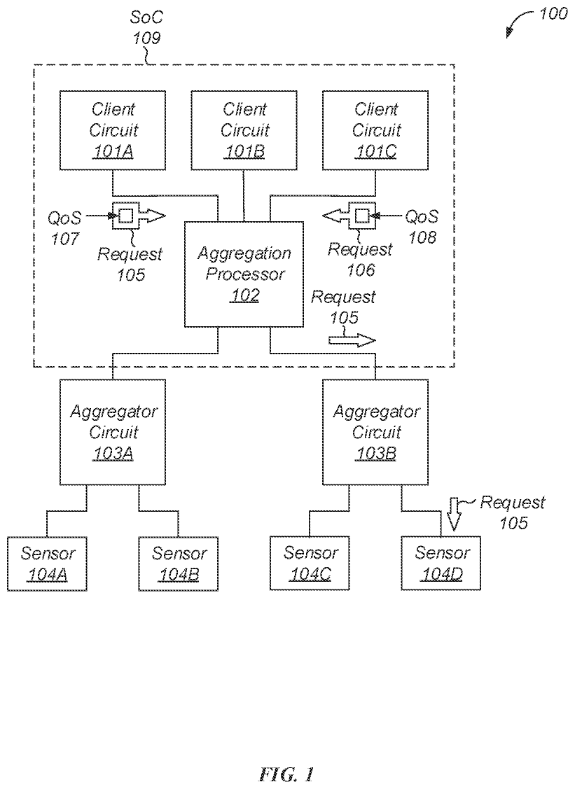

A block diagram of an embodiment of a computer system that uses signal aggregation is depicted in FIG. 1. As illustrated, computer system 100 includes system-on-a-chip 109 (denoted as “SoC 109”) which includes client circuits 101A-101C, and aggregation processor 102. Computer system 100 further includes aggregator circuits 103A and 103B, and sensors 104A-104D.

Client circuits 101A-101C are coupled to aggregation processor 102. In various embodiments, client circuits 101A-101C may be configured to process data from corresponding ones of sensors 104A-104D. Alternatively, or additionally, client circuits 101A-101C may be configured to service interrupts generated by corresponding ones of sensors 104A-104D. In some embodiments, client circuits 101A-101C may generate requests for corresponding ones of sensors 104A-104D. Such requests may, in various embodiments, include a request for data, a request to perform a particular task, and the like.

Although only three client circuits are depicted as being coupled to aggregation processor 102 in the embodiment of FIG. 1, in other embodiments, any suitable number of client circuits may be coupled to aggregation processor 102. In some embodiments, a number of client circuits coupled to aggregation processor 102 may be based on a number of sensors included in computer system 100.

Client circuits 101A-101C may be implemented as general-purpose processor circuits configured to execute software or program instructions. In other embodiments, client circuits 101A-101C may be implemented using microcontroller circuits or any other suitable sequential logic circuit.

Aggregation processor 102 is configured to receive request 105 from client circuit 101A, and relay request 105 to aggregator circuit 103B. In various embodiments, aggregation processor 102 is further configured to receive request 106 from client circuit 101C. In some embodiments, aggregation processor 102 may be configured to generate one or more commands using a first communication protocol to relay request 105 to aggregator circuit 103B.

Aggregation processor 102 may, in some embodiments, be configured to relay request 105 before request 106 based on a comparison of quality-of-service level 107 (denoted as “QoS 107”) associated with request 105 and quality-of-service level 108 (denoted as “QoS 108”) associated with request 106. In various embodiments, aggregation processor 102 may be configured to relay a request with a higher quality-of-service level than other requests with lower quality-of-service levels. A quality-of-service level associated with a particular request may be based on which client circuit generated the request. Requests generated by one client circuit may have higher quality-of-service levels than requests generated by a different client circuit. Additionally, different requests generated by a given client circuit may have different quality-of-service levels depending on a type of the requests.

In some embodiments, aggregation processor 102 may implement access control protocols which control which of client circuits 101A-101C can access which of sensors 104A-104D. For example, the access control protocols may allow client circuit 101A to access sensor 104A, but not sensors 104B-104D. In various embodiments, aggregation processor 102 may receive access control protocols during a boot sequence.

Aggregation processor 102 may, in some embodiments, be configured to automatically issue sensor commands on behalf of clients 101A-101C. In such cases, clients 101A-101C may provide various sensor commands to aggregation processor 102 along with conditions for their execution (e.g., particular times for issuing the sensor commands, etc.). By offloading the issuance of some sensor commands to aggregation processor 102, client circuits 101A-101C may remain in a sleep or low-power mode, thereby reducing overall power consumption.

Aggregator circuit 103B is configured to relay request 105 to sensor 104D. In various embodiments, aggregator circuit 103B may be configured to route request 105 to sensor 104D based on information included in request 105. In some embodiments, aggregator circuit 103B may be further configured to generate one or more commands using a second communication protocol to relay request 105 to sensor 104D. In various embodiments, the second communication protocol may be different than the first communication protocol. In other embodiments, the first and second communication protocols can be the same. It is noted that aggregator circuit 103A is configured to operate in a similar fashion to aggregator circuit 103B.

In various embodiments, aggregator circuits 103A and 103B may record timestamps for various events. For example, aggregator circuit 103A may record a timestamp for an interrupt received from sensor 104A. Aggregator circuits 103A and 103B may be configured to relay recorded timestamp data to aggregation processor 102, which allows aggregation processor 102 to know precise timing of data generated by sensors 104A-104D. As described below, aggregator circuits 103A and 103B may synchronize their respective time bases with aggregation processor 102.

Sensors 104A and 104B are coupled to aggregator circuit 103A, while sensors 104C and 104D are coupled to aggregator circuit 103B. Although only two aggregator circuits and four sensors are depicted in the embodiment of FIG. 1, in other embodiments, any suitable number of aggregator circuits and sensors may be employed. Moreover, although only two sensors are depicted as being coupled to each of aggregator circuits 103A and 103B, in other embodiments, any suitable number of sensors may be coupled to either of aggregator circuit 103A or aggregator circuit 103B.

Sensors 104A-104D are configured to measure respective environmental conditions of computer system 100, or characteristics of a peripheral device coupled to computer system 100. For example, in some embodiments, sensor 104A may be configured to measure ambient light levels where computer system 100 is located. In other embodiments, sensor 104B may be configured to measure a charge level of a battery (not pictured) supplying power to computer system 100.

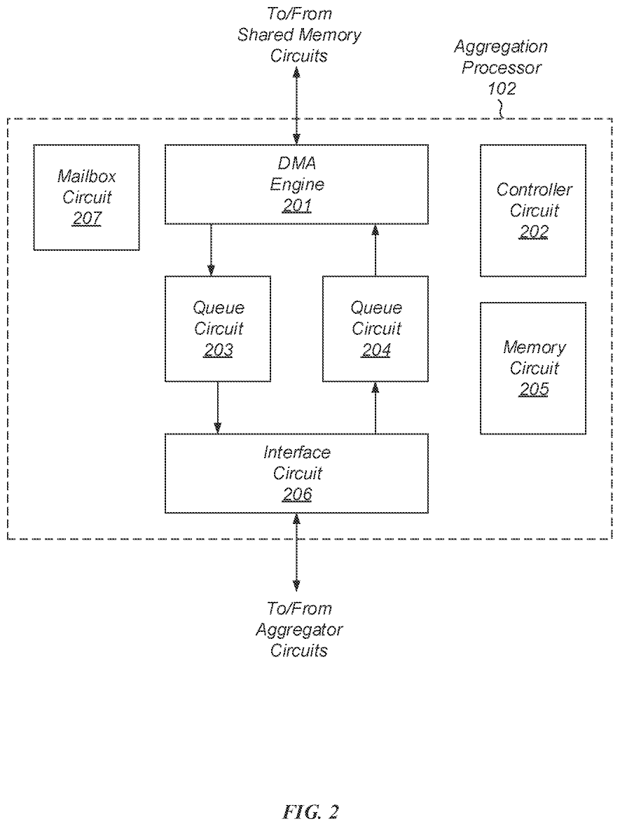

Turning to FIG. 2, a block diagram of an embodiment of aggregation processor 102 is depicted. As illustrated, aggregation processor 102 includes direct-memory access engine 201 (denoted as “DMA engine 201”), controller circuit 202, queue circuit 203, queue circuit 204, memory circuit 205, interface circuit 206, and mailbox circuit 207.

DMA engine 201 is configured to access multiple memory circuits that are shared with corresponding ones of client circuits 101A-101C. In some cases, DMA engine 201 may be configured to read information corresponding to a request (e.g., request 105) from a shared memory circuit. Alternatively, or additionally, DMA engine 201 may be configured to write data indicative of a response to a request to the shared memory circuit.

In various embodiments, DMA engine 201 may be configured to implement one or more communication protocols. For example, in cases where the shared memory circuit is implemented as a piece of system memory, DMA engine 201 may be configured to implement a synchronous dynamic random-access memory (SDRAM) communication protocol. DMA engine 201 may, in various embodiments, be implemented using a microcontroller circuit or any other suitable sequential logic circuit.

Queue circuits 203 and 204 may, in various embodiments, be implemented using respective sets of register circuits. In some embodiments, queue circuits 203 and 204 may be implemented as first-in first-out (FIFO) register circuits, or any other suitable storage circuits.

Interface circuit 206 is configured to relay requests to and from aggregator circuits (e.g., aggregator circuits 103A and 103B as depicted in FIG. 1). To relay a request to an aggregator circuit, interface circuit 206 may be further configured to translate the request from a first communication protocol to a second communication protocol. For example, interface circuit 206 may translate the request from a switch-fabric communication protocol to a system power management interface (“SPMI”). In receiving a response to a request from an aggregator circuit, interface circuit 206 may be configured to receive the response using a particular communication protocol, and translate the response to a different communication protocol compatible with a client circuit, such as one of client circuits 101A-101C.

Memory circuit 205 is configured to store data retrieved by DMA engine 201 from a shared memory circuit. In various embodiments, memory circuit 205 may be implemented as a static random-access memory (SRAM) circuit, register file circuit, or any other suitable storage circuit.

Mailbox circuit 207 is configured to receive messages from one or more client circuits (e.g., client circuits 101A-101C). In some embodiments, a message may include identification information denoting a particular client that generated the message. Additionally, a message can include address information for a location in shared memory that can be accessed by DMA engine 201. In various embodiments, mailbox circuit 207 may generate an interrupt signal for controller circuit 202 in response to receiving a message from a client circuit. In other embodiments, controller circuit 202 may be configured to periodically poll the contents of mailbox circuit 207 to check for new messages. Mailbox circuit 207 may, in some embodiments, be implemented using one or more register circuits along with any suitable combination of sequential and combinatorial logic circuits.

Controller circuit 202 is configured to control the operation of DMA engine 201 and interface circuit 206. In various embodiments, controller circuit 202 may be configured to receive interrupt signals from mailbox circuit 207. Alternatively, controller circuit 202 may be configured to periodically poll mailbox circuit 207 to check for new messages from client circuits. In some embodiments, controller circuit 202 may be configured to prioritize requests and responses in queue circuits 203 and 204 based on quality-of-service levels associated with the requests and responses. Controller circuit 202 may, in various embodiments, be implemented using a dedicated state machine or other sequential logic circuit. In other embodiments, controller circuit 202 may be implemented using a general-purpose processor circuit configured to execute program instructions that implement desired functions of aggregation processor 102.

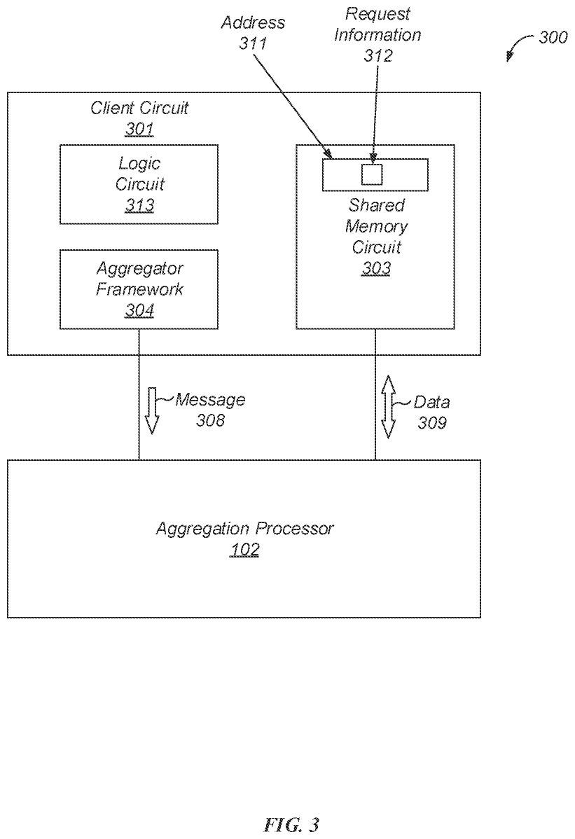

Turning to FIG. 3, a block diagram of an embodiment of a system-on-a-chip that includes a client and an aggregation processor is depicted. As illustrated, system-on-a-chip 300 includes client circuit 301 and aggregation processor 102. In various embodiments, system-on-a-chip 300 may correspond to system-on-a-chip 109 as depicted in FIG. 1.

Client circuit 301 includes aggregator framework 304, shared memory circuit 303, and logic circuit 313. In various embodiments, client circuit 301 may correspond to any of client circuits 101A-101C as depicted in FIG. 1.

Logic circuit 313 is configured to generate request information 312 and store request information 312 at address 311 in shared memory circuit 303. In some cases, logic circuit 313 may be configured to generate request information 312 in response to receiving an interrupt or other signal from a sensor (e.g., sensor 104A) at regular time intervals, or any other suitable criteria.

Logic circuit 313 is also configured to generate message 308 using aggregator framework 304. In various embodiments, aggregator framework 304 may include software instructions and/or hardware logic circuits for formatting and writing message 308 into mailbox circuit 207. In some cases, aggregator framework 304 may include information regarding which of multiple registers included in mailbox circuit 207 is to be used when writing message 308. It is noted that, in various embodiments, message 308 may include information indicative of address 311.

In various embodiments, logic circuit 313 may be implemented using any suitable combination of sequential and combinatorial logic circuits. Logic circuit 313 may, in other embodiments, be implemented as a microcontroller or general-purpose processor circuit.

In response to message 308 being written into mailbox 307, controller circuit 202 may be configured to instruct DMA engine 201 to retrieve data 309 from shared memory circuit 303. In various embodiments, data 309 may correspond to request information 312, and DMA engine 201 may use data included in message 308 (e.g., data indicative of address 311) to retrieve request information 312 from shared memory circuit 303. In some cases, DMA engine 201 may also be configured to write data into shared memory circuit 303. Such data may include data sent from a corresponding sensor of sensors 104A-104D.

Upon retrieving request information 312 from shared memory circuit 303, DMA engine 201 may be further configured to store data indicative of request information 312 into memory circuit 205. Controller circuit 202 may use the data indicative of request information 312 stored in shared memory circuit 303 to relay the request corresponding to request information 312 to one of aggregator circuits 103A or 103B. By using the copy of the data indicative of request information 312 stored in shared memory circuit 303, a further layer of security is provided should request information 312 become corrupted in shared memory circuit 303.

In various embodiments, shared memory circuit 303 may be implemented as a static random-access memory (SRAM) circuit, or any other suitable storage circuit. It is noted that although shared memory circuit 303 is depicted as being included in client circuit 301, in other embodiments, shared memory circuit 303 may be external to client circuit 301. In some cases, shared memory circuit 303 may be shared by more than one client, with each client having a dedicated portion of the address space of shared memory circuit 303 for their respective use.

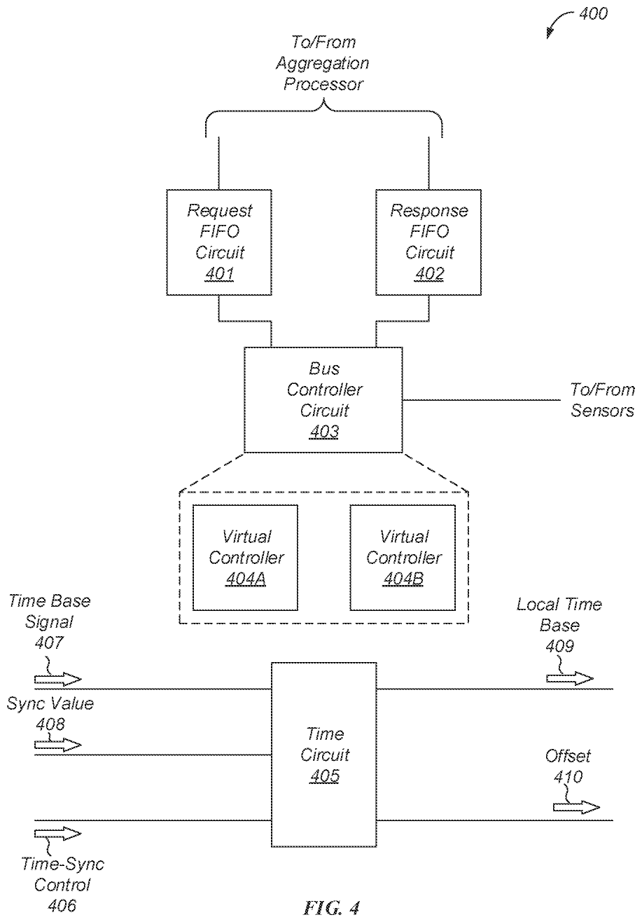

Turning to FIG. 4, a block diagram of an embodiment of an aggregator circuit is depicted. As illustrated, aggregator circuit 400 includes request FIFO circuit 401, response FIFO circuit 402, bus controller circuit 403, virtual controllers 404A and 404B, and time circuit 405.

Bus controller circuit 403 is configured to send requests from request FIFO circuit 401 to one of multiple sensors (e.g., sensor 104A) coupled to aggregator circuit 400. Additionally, bus controller circuit 403 is configured to receive responses from multiple sensors (e.g., sensor 104A) and store the received responses in response FIFO circuit 402. In some cases, bus controller circuit 403 may be configured, in response to receiving multiple responses in parallel, to store the multiple responses in response FIFO circuit 402 according to respective quality-of-service levels associated with the multiple responses.

In some cases, sensors coupled to aggregator circuit 400 may employ different communication protocols. To accommodate such different communication protocols, bus controller circuit 403 may employ virtual controllers 404A and 404B. In some embodiments, virtual controllers 404A and 404B may be implemented using software or firmware executed by bus controller circuit 403. Virtual controller 404A may emulate one communication protocol, while virtual controller 404B may emulate another communication protocol. By employing virtual controllers, bus controller circuit 403 can rapidly switch between different communication protocols without having dedicated circuitry configured to implement the different communication protocols. In various embodiments, bus controller circuit 403 may be implemented as a microcontroller, a general-purpose processor circuit, or any other suitable combination of sequential and combinatorial logic circuits.

Request FIFO circuit 401 and response FIFO circuit 402 may be implemented using any suitable first-in first-out (FIFO) circuits. In various embodiments, a FIFO circuit may include multiple registers configured to store words of data. Additionally, a FIFO circuit may include a sequential logic circuit to track an order in which data is stored in the FIFO circuit, so that older data can be read before newer data.

Time circuit 405 is configured to receive time base signal 407 and generate local time base 409 using time base signal 407. In various embodiments, time base signal 407 may be generated by a computer system such as computer system 100 as depicted in FIG. 1. In response to an activation of time-sync control 406, time circuit 405 is further configured to latch a value of local time base 409. Time circuit 405 is also configured to receive sync value 408. In some embodiments, sync value 408 is generated by aggregation processor 102 and is a latched value of a local time base generated by aggregation processor 102 that was also latched in response to the activation of time-sync control 406. In various embodiments, time circuit 405 is further configured to generate offset 410, which may be used to adjust local time base 409 in order to generate timestamps for data received from sensors 104A-104D. To generate offset 410, time circuit 405 may, in some embodiments, determine a difference between the latched value of local time base 409 and sync value 408.

It is noted that, in some embodiments, aggregator circuit 400 may be configured to implement Precision Time Protocol (“PTP”) over SPMI to track the time base of aggregation processor 102. In various embodiments, PTP over SPMI made be used in lieu of, or in addition to, the time synchronization method described above.

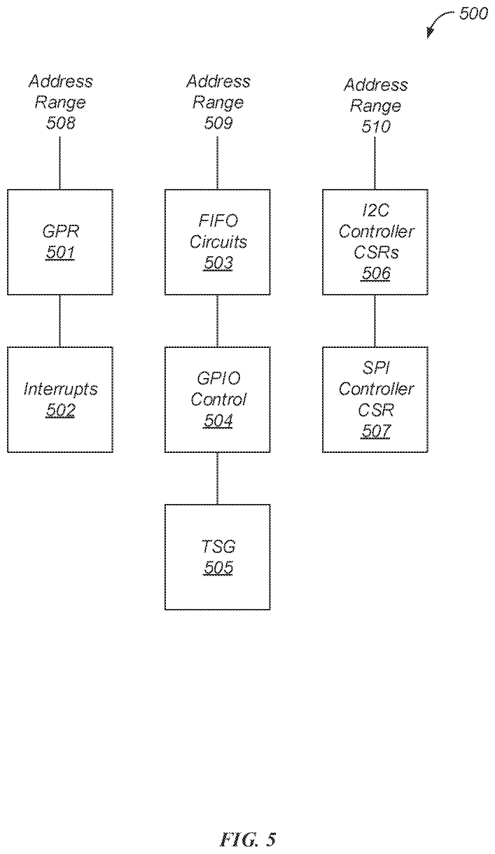

Turning to FIG. 5, a block diagram of an embodiment of an address map for an aggregator circuit is depicted. In various embodiments, address map 500 may be used by aggregation processor 102 to send commands for particular functions within an aggregator circuit, such as aggregator circuit 103A.

As illustrated, general purpose register 501 (denoted as “GPR 501”) and interrupts 502 are assigned to address range 508. In various embodiments, address range 508 may be at the low end of the entire address space. In some communication protocols, e.g., SPMI, transactions at the low end of the address range require less communication overhead and may, therefore, be more efficient. Accordingly, frequently accessed functions or sub-circuits, e.g., GPR 501 and interrupts 502, may be assigned to the low end of the address space.

FIFO circuits 503, general-purpose input/output (GPIO) control 504, and time sync generation (TSG) 505 are included in address range 509. In various embodiments, address range 509 includes addresses greater than the largest address in address range 508 and less than the smallest address in address range 510.

I2C controller control/status registers (CSRs) 506 and SPI controller CSR 507 are included in address range 510. In various embodiments, address range 510 includes addresses greater than the largest address in address range 509.

It is noted that the functions assigned to the different address ranges are merely examples. In other embodiments, different functions, including functions not depicted in FIG. 5, may be assigned to any suitable address range.

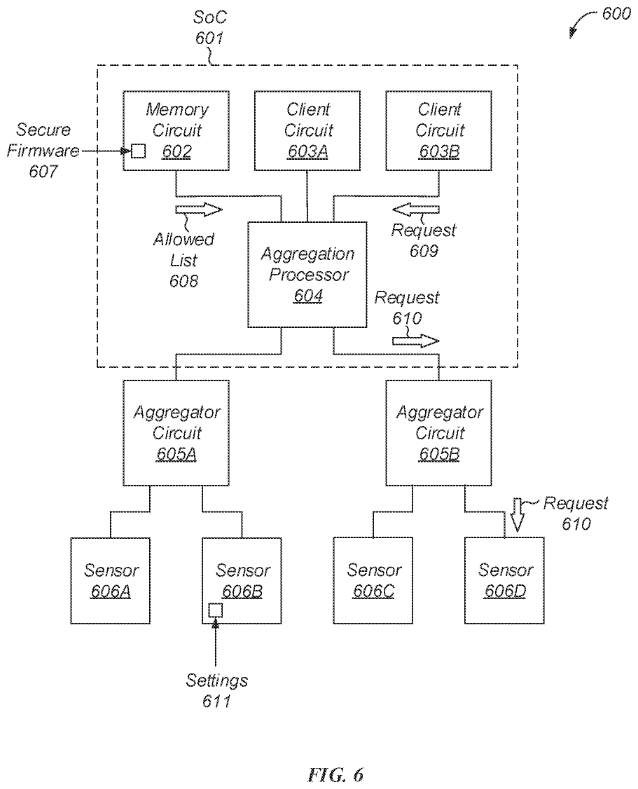

Turning to FIG. 6, a block diagram of an embodiment of a computer system that uses security checks and signal aggregation is depicted. As illustrated, computer system 600 includes system-on-a-chip 601 (denoted as “SoC 601”), aggregator circuits 605A and 605B, and sensors 606A-606D. SoC 601 includes memory circuit 602, client circuits 603A and 603B, and aggregation processor 604. In various embodiments, computer system 600 may correspond to computer system 100 as depicted in FIG. 1.

Memory circuit 602 is configured to store secure firmware 607, which includes allowed list 608. In various embodiments, memory circuit 602 may be implemented using a one-time programmable memory circuit that is programmed with secure firmware 607 during manufacture, final test, or any other suitable time prior to receipt of computer system 600 by a user.

In various embodiments, allowed list 608 may include a list of allowed commands that may be executed by client circuits 603A and 603B. In some cases, there may be different sets of allowed commands for different ones of client circuits 603A and 603B. Allowed list 608 may, in some embodiments, include a list of sensor settings, e.g., settings 611, that can be modified by one of client circuits 603A and 603B.

Aggregation processor 604 is configured to retrieve allowed list 608 from memory circuit 602. In some cases, aggregation processor 604 may be configured to retrieve allowed list 608 from memory circuit 602 and store a local copy of allowed list 608 during a startup or boot process. Alternatively, aggregation processor 604 may be configured to retrieve allowed list 608 in response to receiving a request, e.g., request 609, from one of client circuits 603A or 603B.

In various embodiments, aggregation processor 604 is configured to receive request 609 from client circuit 603B. In response to receiving request 609, aggregation processor 604 is configured to perform a comparison of a command included in request 609 to allowed list 608. Aggregation processor 604 is further configured to send request 610 to aggregator circuit 605B based on a result of the comparison. It is noted that request 610 may include all or part of request 609. In various embodiments, aggregator circuit 605B is configured to send (or “relay”) request 610 to sensor 606D. Although aggregation processor 604 is depicted as sending or relaying sending request 610 to aggregator circuit 605B, in other embodiments, aggregation processor 604 may be configured to send request 610 to aggregator circuit 605A based on information included in request 609.

In various embodiments, to send request 610 to aggregator circuit 605B based on a result of the comparison, aggregation processor 604 is further configured to send request 610 to aggregator circuit 605B in response to a determination that the command included in request 609 is included in allowed list 608. In response to a determination that the command included in request 609 is not included in allowed list 608, aggregation processor 604 may be configured to perform one or more security operations. For example, in some cases, aggregation processor 604 may be configured to disable client 603B, initiate a restart of computer system 600, shutdown computer system 600, or any other suitable security operation.

In some cases, an aggregation processor may be used to offload one or more tasks from a client circuit in an SoC. By having the aggregation processor perform such tasks, one or more client circuits in the SoC can be put in a sleep or low-power mode to save system power until they are needed.

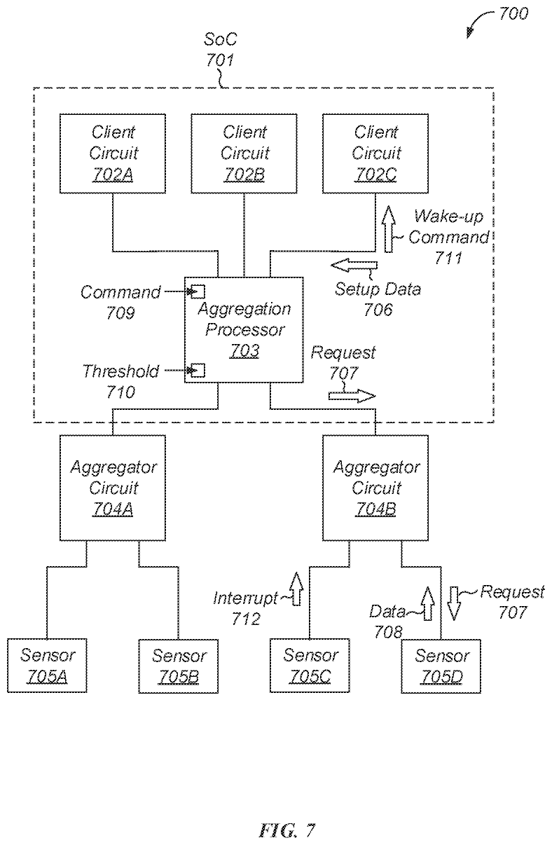

A block diagram depicting an embodiment of a computer system where an aggregation processor can offload tasks from a client is depicted in FIG. 7. As illustrated, computer system 700 includes system-on-a-chip 701 (denoted as “SoC 701”), aggregator circuits 704A and 704B, and sensors 705A-705D. SoC 701 includes client circuits 702A-702C, and aggregation processor 703. In various embodiments, computer system 700 may correspond to computer system 100 as depicted in FIG. 1.

Client circuit 702C is configured to send setup data 706 to aggregation processor 703. In various embodiments, client circuit 702C is configured to send setup data 706 during a startup or boot operation of computer system 700. In some embodiments, client circuit 702C may be configured to enter a sleep or low-power mode once setup data 706 has been sent to aggregation processor 703. Although client circuit 702C is depicted as the only one of client circuits 702A-702C sending setup data, in other embodiments, any suitable combination of client circuits 702A-702C may send corresponding setup data to aggregation processor 703.

Aggregation processor 703 is configured, based on setup data 706, to perform at least one periodic task on behalf of client circuit 702C. In some embodiments, to perform the at least one periodic task, aggregation processor 703 may be further configured to send request 707 to aggregator circuit 704B, which is, in turn, relayed to sensor 705D. Although aggregation processor 703 is depicted as sending a single request to a particular aggregator circuit, in other embodiments, aggregation processor 703 may be configured to perform different periodic tasks for different ones of client circuits 702A-702C which may include sending other requests to different ones of sensors 705A-705D.

In various embodiments, the periodicity of the at least one periodic task is defined in setup data 706. A type of the at least one periodic task, e.g., polling one or more of sensors 702A-702D, storing data, e.g., data 708, received from any of sensors 702A-702D, may also be specified in setup data 706. For example, in some embodiments, setup data 706 may specify that command 709 be executed at regular intervals.

In various embodiments, aggregation processor 703 may be further configured to send wake-up command 711 to client circuit 702C in response to receiving interrupt 712 from sensor 705C. In some cases, aggregation processor 703 may be further configured to send wake-up command 711 in response to a number of received interrupts from a given one of sensors 705A-705D that exceeds threshold 710. In some embodiments, a value for threshold 710 may be included in setup data 706.

Client circuit 702C is configured to exit a sleep or low-power mode in response to receiving wake-up command 711. In response to a determination that client circuit 702C has exited the sleep or low-power mode, aggregation processor 703 may be further configured to send data 708, which was gathered while client circuit 702C was in the sleep or low-power mode, to client circuit 702C.

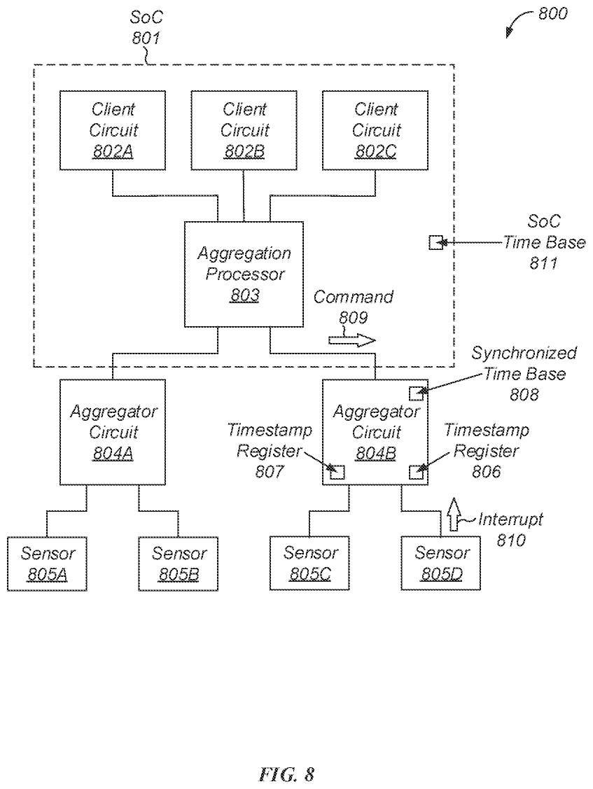

Turning to FIG. 8 a block diagram of an embodiment of a computer system that timestamps events is depicted. As illustrated, computer system 800 includes system-on-a-chip 801 (denoted as “SoC 801”), aggregator circuits 804A and 804B, and sensors 805A-805D. SoC 801 includes client circuits 802A-802C, and aggregation processor 803. In various embodiments, computer system 800 may correspond to computer system 100 as depicted in FIG. 1.

Sensor 805D is configured to measure a particular characteristic of computer system 800. In various embodiments, sensor 805D is further configured, in response to a determination that the particular characteristic exceeds a threshold value, to generate interrupt 810.

Aggregator circuit 804B is configured to receive interrupt 810 generated by sensor 805D, and to generate a timestamp for interrupt 810. In some embodiments, the timestamp is based on synchronized time base 808, which is synchronized to SoC time base 811. In various embodiments, aggregator circuit 804B includes timestamp registers 806 and 807, and is further configured to store data indicative of the timestamp in timestamp register 806. Although aggregator circuit 804B is depicted as being coupled to two sensors, in other embodiments, aggregator circuit 804B may be coupled to any suitable number of sensors, and aggregator circuit 804B may include a number of timestamp registers corresponding to a number of sensors.

Aggregation processor 803 is configured to retrieve the data indicative of the timestamp. To retrieve the data indicative of the timestamp, aggregation processor 803 is further configured to send a register read command to aggregator circuit 804B. In some embodiments, aggregation processor 803 is also configured, once the data indicative of the timestamp has been retrieved, to send the data indicative of the timestamp to a particular client circuit of client circuits 802A-802C that is configured to manage the operation of sensor 805D.

As described above, events such as interrupts can be timestamped by aggregator circuits using synchronized time bases. To synchronize time bases between an SoC and multiple aggregator circuits, respective clock signals need to be sent to the aggregator circuits. Such clock signals can result in additional power consumption. In some cases, time bases can be synchronized using messages transmitted over a communication bus without using dedicated clock signals.

A block diagram showing two circuit blocks synchronizing their respective time bases using messages transmitted over a communication bus between the two circuit blocks is depicted. As illustrated, computer system 900 includes circuit block 901 and circuit block 902. Circuit block 901 includes egress register circuit 903A and receive register circuit 903B, while circuit block 902 includes trigger register circuit 904A, and delay register circuit 904B. It is noted that circuit blocks 901 and 902 may include respective sets of sub-circuits which have been omitted for clarity. It is further noted that, in various embodiments, circuit block 901 may correspond to aggregation processor 102, and circuit block 902 may correspond to either of aggregator circuit 103A or 103B as depicted in FIG. 1.

At time t0, circuit block 901 is configured to send write command 905 to circuit block 902 to store a value in trigger register circuit 904A, which arrives at circuit block 902 at time t1. In various embodiments, write command 905 may be sent using the SPMI communication protocol. In various embodiments, circuit block 901 is further configured to store to in egress register circuit 903A.

In response to receiving write command 905, circuit block 902 is configured to send write command 906 to circuit block 901 at time t2. In various embodiments, circuit block 902 is also configured to store delay data 908, which is a difference between times t1 and t2, in delay register circuit 904B. As with write command 905, write command 906 may also be implemented using the SPMI communication protocol, and may include a write to a general-purpose register in circuit block 901.

Upon receiving write command 906 at time t3, circuit block 901 is configured to store time t3 in receive register circuit 903B. Once time t3 has been stored in receive register circuit 903B, circuit block 901 is further configured to send read command 907 to circuit block 902 to retrieve delay data 908 from delay register circuit 904B. Using delay data 908, circuit block 901 is further configured to determine tDelay 903C using Equation 1, wherein tDelay is the value of delay data 908.

$$tDelay = \frac{1}{2} ( t 3 - t 0 - ( t 2 - t 1 ) ) . \qquad ( 1 )$$

Circuit block 901 is also configured to send read command 910 at time to′ which arrives at circuit block 902 at time t1′. Circuit block 902 is configured to immediately respond with the value of time t1′. In various embodiments, the value of t1′ corresponds to time, according to the local clock of circuit block 902, when the header of read command 910 is received. Circuit block 901 is further configured to calculate tOffset 903D using Equation 2. Using tOffset, 903D circuit block 901 can be configured to adjust timestamp values received from circuit block 902 to synchronize the timestamp values with its local time base.

$$tOffset = t {1}^{′} - t {0}^{′} - tDelay . \qquad ( 2 )$$

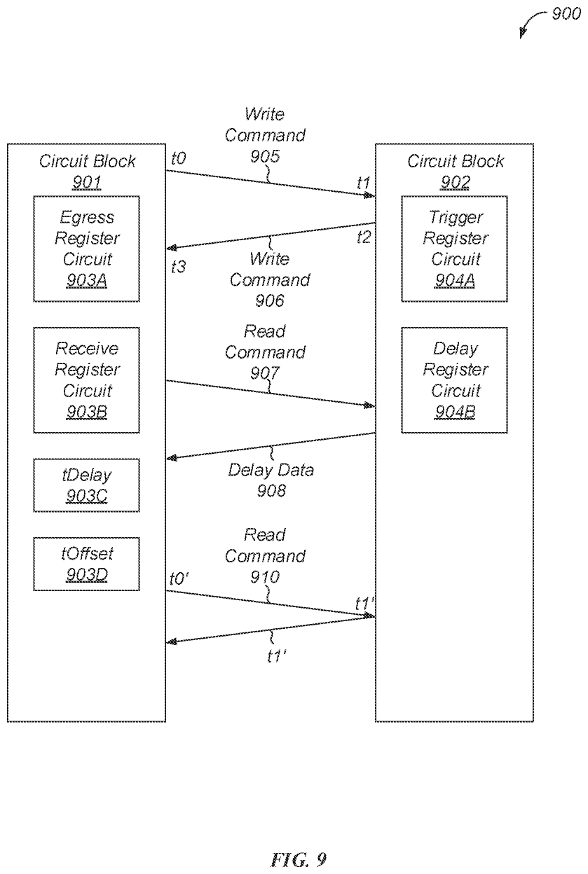

The operation described above may be performed as part of system initialization. In other embodiments, the operation may be performed at regular intervals to maintain synchronization between circuit blocks 901 and 902. It is noted that, for the embodiment depicted in FIG. 9, the delay for a message to travel from circuit block 901 to circuit block 902 is assumed to be the same as the delay for a message to travel from circuit block 902 to circuit block 901.

To summarize, various embodiments of a signal aggregator are disclosed. Broadly speaking, multiple aggregator circuits may be coupled to corresponding subsets of multiple sensors. A particular client of multiple clients may generate a request for a particular sensor of the multiple sensors. An aggregation processor may receive the request from the particular client and relay the request to a particular aggregator circuit coupled to the particular sensor. The particular aggregator circuit may be configured to relay the request to the particular sensor.

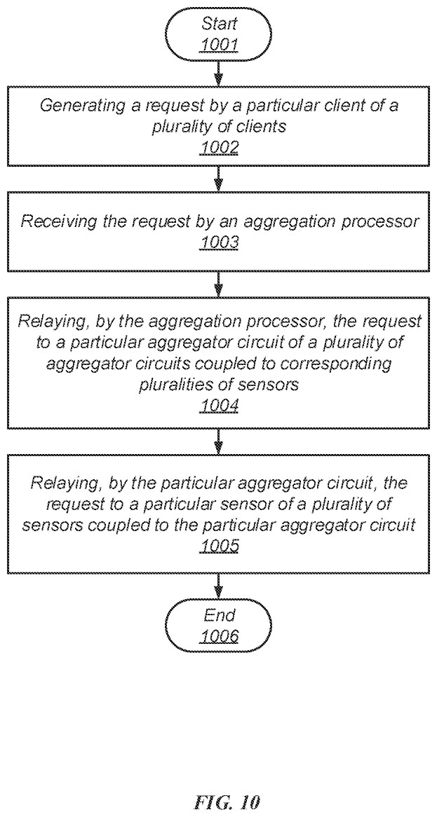

Turning to FIG. 10, a flow diagram depicting an embodiment of a method for operating a computer system that uses signal aggregation is illustrated. The method, which may be applied to various computer systems, including computer system 100 as depicted in FIG. 1, begins in block 1001.

The method includes generating a request by a particular client of a plurality of clients (block 1002). The request may, in some embodiments, be a request for data from a sensor in the computer system. Alternatively, the request may include a command or other instructions for the sensor. In various embodiments, generating the request by the particular client includes writing, by the particular client, a message into a mailbox circuit included in the aggregation processor.

The method also includes receiving the request by an aggregation processor (block 1003). In some cases, the message includes an address corresponding to a location in a memory circuit shared by the particular client and the aggregation processor. In some embodiments, receiving the request by the aggregation processor may include reading, by the aggregation processor using the address, information indicative of the request from the memory circuit.

The method further includes relaying, by the aggregation processor, the request to a particular aggregator circuit of a plurality of aggregator circuits coupled to corresponding pluralities of sensors (block 1004). In some embodiments, relaying the request to the particular aggregator circuit includes relaying, by the aggregation processor, the request to the particular aggregator circuit using a first communication protocol.

As described above, a given request may be associated with a quality-of-service level of either the client that originated the request or a sensor that is to receive the request. In various embodiments, the method may include initializing the quality-of-service levels during a boot operation. When quality-of-service levels are employed, relaying the request to the particular aggregator circuit may include determining an order for relaying the particular request along with a plurality of previously received requests according to respective quality-of-service levels.

The method also includes relaying, by the particular aggregator circuit, the request to a particular sensor of a plurality of sensors coupled to the particular aggregator circuit (block 1005). In some embodiments, relaying the request to the particular sensor may include relaying, by the aggregator circuit, the request using a second communication protocol different than the first communication protocol. The method ends in block 1006.

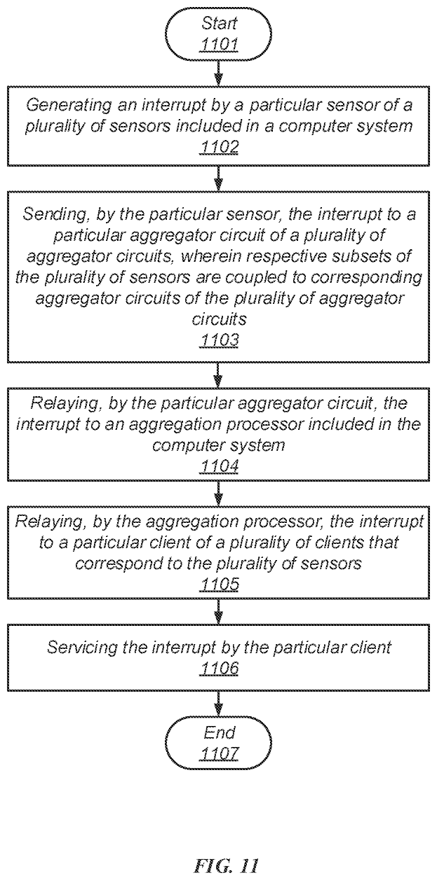

Turning to FIG. 11, a flow diagram depicting an embodiment of a method for processing interrupts in a computer system that uses signal aggregation is illustrated. The method, which may be applied to various computer systems, including computer system 100 as depicted in FIG. 1, begins in block 1101.

The method includes generating an interrupt by a particular sensor of a plurality of sensors included in a computer system (block 1102). In various embodiments, the method may further include measuring a particular environmental condition of the computer system, and performing a comparison of a value of the particular environmental condition to a threshold value. In such cases, the method may include generating the interrupt based on a result of the comparison.

The method also includes sending, by the particular sensor, the interrupt to a particular aggregator circuit of a plurality of aggregator circuits (block 1103). In various embodiments, respective subsets of the plurality of sensors are coupled to corresponding aggregator circuits of the plurality of aggregator circuits. In some embodiments, the method may include sending the interrupt to the particular aggregator circuit using a first communication protocol.

The method further includes relaying, by the particular aggregator circuit, the interrupt to an aggregation processor included in the computer system (block 1104). In some embodiments, the method may include relaying the interrupt to the aggregation processor using a second communication protocol different from the first communication protocol.

The method also includes relaying, by the aggregation processor, the interrupt to a particular client of a plurality of clients that correspond to the plurality of sensors (block 1105). In various embodiments, relaying the interrupt to the particular client may include writing a particular value to a register included in the particular client.

The method further includes servicing the interrupt by the particular client (block 1106). In various embodiments, servicing the interrupt includes performing at least one operation by the particular client. In some cases, the at least one operation may include halting or otherwise suspending the operation of the computer system. The method ends in block 1107.

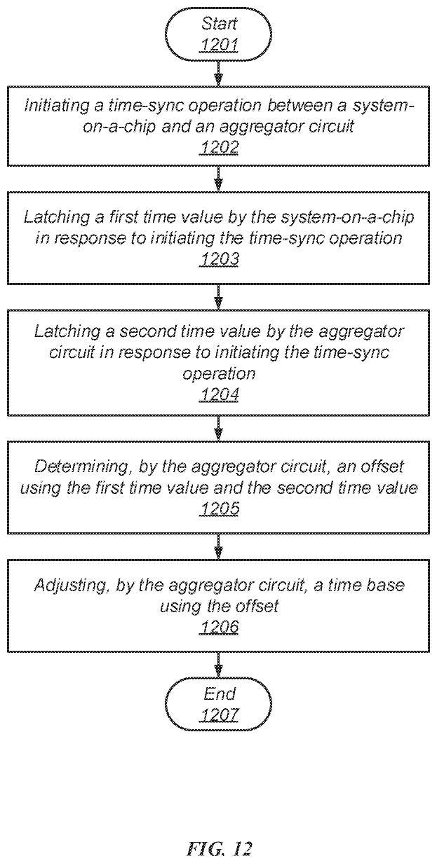

Turning to FIG. 12, a flow diagram depicting an embodiment of a method for time-syncing an SoC and an aggregator circuit is illustrated. The method, which may be applied to various SoCs (e.g., SoC 109) and various aggregator circuits (e.g., aggregator circuits 103A and 103B), begins in block 1201.

The method includes initiating a time-sync operation between a system-on-a-chip and an aggregator circuit (block 1202). In various embodiments, the time-sync operation may be initiated at periodic intervals by the system-on-a-chip. In other embodiments, the time-sync operation may be initiated in response to a particular operation performed by the system-on-a-chip, or in response to detecting a particular event.

The method also includes latching a first time value by the system-on-a-chip in response to initiating the time-sync operation (block 1203). In various embodiments, the method includes sending, by the system-on-a-chip, the first time value to the aggregator circuit.

The method further includes latching a second time value by the aggregator circuit in response to initiating the time-sync operation (block 1204). In some embodiments, the method includes receiving the second time value from the system-on-a-chip.

The method also includes determining, by the aggregator circuit, an offset using the first time value and the second time value (block 1205). In various embodiments, determining the offset includes calculating a difference between the first time value and the second time value.

The method further includes adjusting, by the aggregator circuit, a time base using the offset (block 1206). In various embodiments, adjusting the time base includes adding the offset to a value of the time base. The method concludes in block 1207.

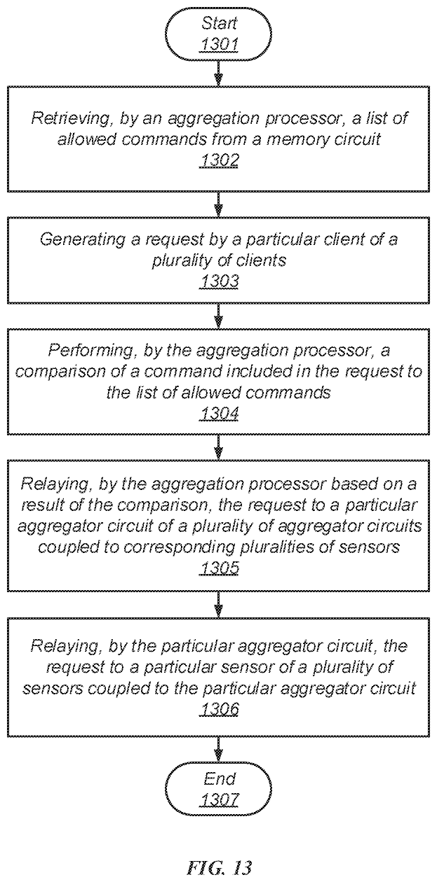

Turning to FIG. 13, a flow diagram depicting an embodiment of a method for using security checks in a computer system that employs signal aggregation is illustrated. The method, which may be applied to various computer systems, e.g., computer system 600 as depicted in FIG. 6, begins in block 1301.

The method includes retrieving, by an aggregation processor, a list of allowed commands from a memory circuit (block 1302). In various embodiments, the memory circuit and the aggregation processor are included in an SoC. In some cases, the memory circuit is a one-time programmable memory circuit programmed at a manufacturing facility, and the list of allowed commands is included as part of secure firmware that is stored in the memory circuit.

In some embodiments, the list of allowed commands may be client and/or sensor specific, i.e., the list of allowed commands may include a first set of commands that can be executed by a first client, and a second set of commands, different than the first set of commands, that can be executed by a second client. In other embodiments, the list of allowed commands may include one or more commands that can be executed a single time during setup of the computer system. For example, the list of allowed commands may include sensor setup commands that once executed, cannot be executed again until the computer system has been rebooted.

The method further includes generating a request by a particular client of a plurality of clients (block 1303). In some embodiments, the plurality of clients are included on the SoC and are coupled to the aggregation processor through a corresponding communication channel, a switch fabric, or any other suitable communication circuit.

The method also includes performing, by the aggregation processor, a comparison of a command included in the request to the list of allowed commands (block 1304). In some embodiments, performing the comparison may include checking if the command has been previously executed, or checking identification indicative of which client initiated the request.

The method further includes relaying, by the aggregation processor based on a result of the comparison, the request to a particular aggregator circuit of a plurality of aggregator circuits coupled to corresponding pluralities of sensors (block 1305). In various embodiments, the method may include relaying the request to the particular aggregator circuit in response to determining the command is included in the list of allowed commands. In other embodiments, the method may include performing a security operation, e.g., executing a system shutdown, in response to determining that the command is not included in the list of allowed commands.

The method also includes relaying, by the particular aggregator circuit, the request to a particular sensor of a plurality of sensors coupled to the particular aggregator circuit (block 1306). The method concludes in block 1307.

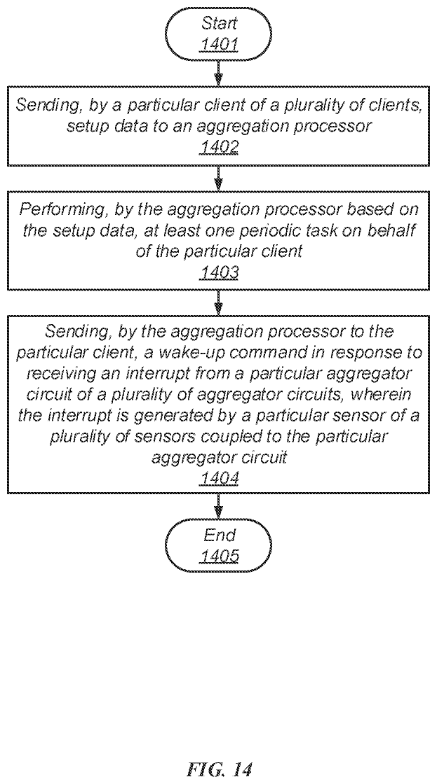

Turning to FIG. 14, a flow diagram depicting an embodiment of a method for offloading processing tasks from a client in a computer system that uses signal aggregation is illustrated. The method, which may be applied to various computer systems, e.g., computer system 700 as depicted in FIG. 7, begins in block 1401.

The method includes sending, by a particular client of a plurality of clients, setup data to an aggregation processor (block 1402). In various embodiments, the setup data may specify a particular sensor of a plurality of sensors that are coupled to a particular aggregator circuit of a plurality of aggregator circuits. In some cases, the plurality of clients and the aggregation processor may be located on an SoC.

The method also includes performing, by the aggregation processor based on the setup data, at least one periodic task on behalf of the particular client (block 1403). In some cases, the periodicity of the task may be defined in the setup data, and may include polling one or more sensors and storing data from the one or more sensors.

The method further includes sending, by the aggregation processor to the particular client a wake-up command in response to receiving an interrupt from the particular aggregator circuit (block 1404). In various embodiments, the interrupt is generated by the particular sensor.

In some embodiments, the method may further include sending the wake-up command in response to receiving, by the aggregation processor, a threshold number of interrupts from the particular aggregator circuit. In some cases, the threshold number may be included in the setup data. In other embodiments, the method may also include sending the wake-up command in response to determining, by the aggregation processor, that a particular period of time as defined in the setup data has elapsed.

In some embodiments, the method may further include sending, by the aggregator processor in response to determining the particular client is active after receiving the wake-up command, previously stored data from one or more sensors of the plurality of sensors to the particular client. The method concludes in block 1405.

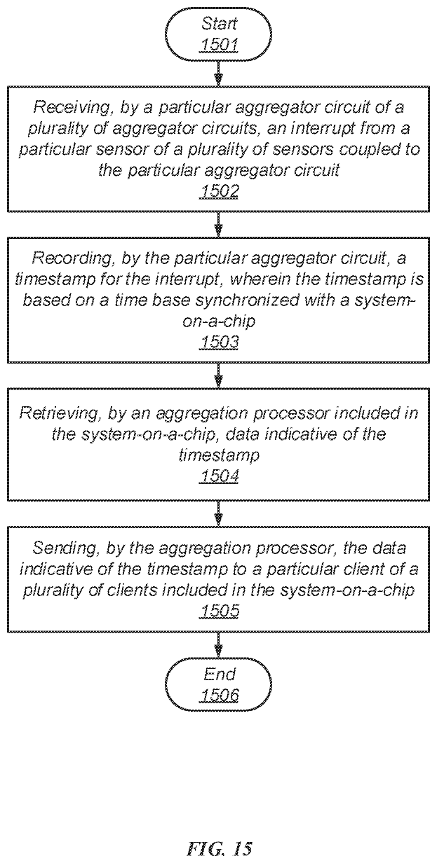

Turning to FIG. 15, a flow diagram depicting an embodiment of a method for timestamping events in a computer system that uses signal aggregation is illustrated. The flow diagram, which may be applied to various computer systems, e.g., computer system 800 as depicted in FIG. 8, begins in block 1501.

The method includes receiving, by a particular aggregator circuit of a plurality of aggregator circuits, an interrupt from a particular sensor of a plurality of sensors coupled to the particular aggregator circuit (block 1502). In some embodiments, the method may further include measuring, by the particular sensor, a particular characteristic of the computer system, and generating, by the particular sensor, the interrupt in response to determining a particular characteristic exceeds a threshold value.

The method also includes recording, by the particular aggregator circuit, a timestamp for the interrupt (block 1503). In some embodiments, the timestamp is based on a time base synchronized with a system-on-a-chip (“SoC”). In various embodiments, recording the timestamp includes storing the timestamp in a register circuit included in the particular aggregator circuit.

The method further includes retrieving, by an aggregation processor included in the SoC, data indicative of the timestamp (block 1504). In some embodiments, retrieving the data indicative of the timestamp includes sending, by the aggregation processor, a register read command to the particular aggregator circuit.

The method also includes sending, by the aggregation processor, the data indicative of the timestamp to a particular client of a plurality of clients included in the SoC (block 1505). In some embodiments, the method further includes storing, by the particular client, the data indicative of the timestamp in a register circuit included in the particular client. The method concludes in block 1506.

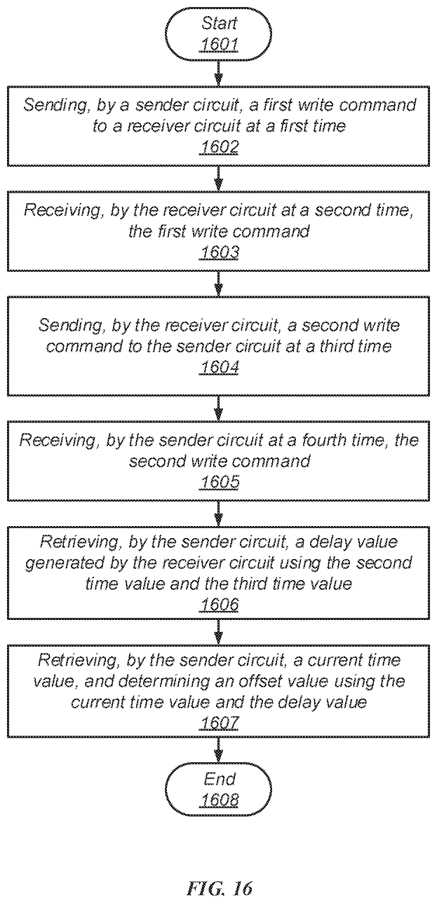

Turning to FIG. 16, a flow diagram depicting an embodiment of a method for synchronizing time bases between two different circuit blocks is illustrated. The method, which may be applied to different circuit blocks, e.g., circuit blocks 901 and 902 as depicted in FIG. 9, begins in block 1601.

The method includes sending, by a sender circuit, a first write command to a receiver circuit at a first time (block 1602). In various embodiments, the first write command may be formatted according to the SPMI communication protocol. In some embodiments, the method may also include storing, by the sender circuit, the first time in a first register circuit included in the sender circuit.

The method also includes receiving, by the receiver circuit at a second time, the first write command (block 1603). The method further includes sending, by the receiver circuit, a second write command to the sender circuit at a third time (block 1604). In some cases, the second write command may also be formatted according to the SPMI communication protocol, and may be a write to a general-purpose register. In various embodiments, the method may also include determining a delay value using the second time value and the third time value. In some embodiments, determining the delay value may including determining half of a difference between the third time value and the second time value.

The method further includes receiving, by the sender circuit at a fourth time, the second write command (block 1605). The method also includes receiving, by the sender circuit, a delay value generated by the receiver circuit using the second time value and the third time value (block 1606).

The method further includes retrieving, by the sender circuit, a current time value, and determining an offset value using the current time value and the delay value (block 1607). Retrieving the current time value may, in some embodiments, including sending, by the sender circuit, a read command to the receiver circuit, and sending, by the receiver circuit to the sender circuit, the current time value. In various embodiments, the current time corresponds to a time, according to a local clock of the receiver circuit, when a header of the read command was received.

In some embodiments, determining the offset value includes subtracting a time when the read command was sent and the delay value from the current time. In various embodiments, the method may additionally include adjusting, by the sender circuit, timestamp values received from the receiver circuit using the offset. The method concludes in block 1608.

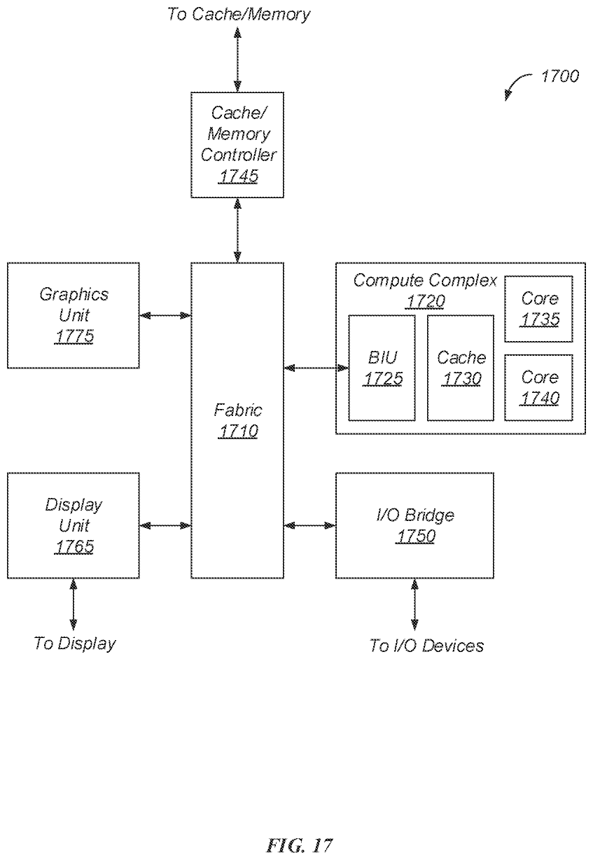

Referring now to FIG. 17, a block diagram illustrating an example embodiment of a device is shown that may include aggregator circuits and an aggregation processor. In various embodiments, device 1700 may implement functionality of aggregation processor 102 as depicted in FIG. 1. In some embodiments, elements of device 1700 may be included within a system on a chip. In some embodiments, device 1700 may be included in a mobile device, which may be battery-powered. Therefore, power consumption by device 1700 may be an important design consideration. In the illustrated embodiment, device 1700 includes fabric 1710, compute complex 1720, input/output (I/O) bridge 1750, cache/memory controller 1745, graphics unit 1775, and display unit 1765. In some embodiments, device 1700 may include other components (not shown) in addition to, or in place of, the illustrated components, such as video processor encoders and decoders, image processing or recognition elements, computer vision elements, etc.

Fabric 1710 may include various interconnects, buses, MUX's, controllers, etc., and may be configured to facilitate communication between various elements of device 1700. In some embodiments, portions of fabric 1710 may be configured to implement various different communication protocols. In other embodiments, fabric 1710 may implement a single communication protocol, and elements coupled to fabric 1710 may convert from the single communication protocol to other communication protocols internally.

In the illustrated embodiment, compute complex 1720 includes bus interface unit (BIU) 1725, cache 1730, and cores 1735 and 1740. In various embodiments, compute complex 1720 may include various numbers of processors, processor cores, and caches. For example, compute complex 1720 may include 1, 2, or 4 processor cores, or any other suitable number. In one embodiment, cache 1730 is a set associative L2 cache. In some embodiments, cores 1735 and 1740 may include internal instruction and data caches. In some embodiments, a coherency unit (not shown) in fabric 1710, cache 1730, or elsewhere in device 1700, may be configured to maintain coherency between various caches of device 1700. BIU 1725 may be configured to manage communication between compute complex 1720 and other elements of device 1700. Processor cores, such as cores 1735 and 1740, may be configured to execute instructions of a particular instruction set architecture (ISA) which may include operating system instructions and user application instructions. These instructions may be stored in a computer readable medium such as a memory coupled to cache memory controller 1745 as discussed below.

As used herein, the term “coupled to” may indicate one or more connections between elements, and a coupling may include intervening elements. For example, in FIG. 17, graphics unit 1775 may be described as “coupled to” a memory through fabric 1710 and cache/memory controller 1745. In contrast, in the illustrated embodiment of FIG. 17, graphics unit 1775 is “directly coupled” to fabric 1710 because there are no intervening elements.

Cache/memory controller 1745 may be configured to manage transfer of data between fabric 1710 and one or more caches and memories. For example, cache/memory controller 1745 may be coupled to an L3 cache, which may, in turn, be coupled to a system memory. In other embodiments, cache/memory controller 1745 may be directly coupled to a memory. In some embodiments, cache/memory controller 1745 may include one or more internal caches. Memory coupled to cache/memory controller 1745 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 1745 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1720 to cause the computing device to perform functionality described herein.

Graphics unit 1775 may include one or more processors, e.g., one or more graphics processing units (GPUs). Graphics unit 1775 may receive graphics-oriented instructions, such as OPENGL®, Metal®, or DIRECT3D® instructions, for example. Graphics unit 1775 may execute specialized GPU instructions or perform other operations based on the received graphics-oriented instructions. Graphics unit 1775 may generally be configured to process large blocks of data in parallel, and may build images in a frame buffer for output to a display, which may be included in the device or may be a separate device. Graphics unit 1775 may include transform, lighting, triangle, and rendering engines in one or more graphics processing pipelines. Graphics unit 1775 may output pixel information for display images. Graphics unit 1775, in various embodiments, may include programmable shader circuitry which may include highly parallel execution cores configured to execute graphics programs, which may include pixel tasks, vertex tasks, and compute tasks (which may or may not be graphics-related).

Display unit 1765 may be configured to read data from a frame buffer and provide a stream of pixel values for display. Display unit 1765 may be configured as a display pipeline in some embodiments. Additionally, display unit 1765 may be configured to blend multiple frames to produce an output frame. Further, display unit 1765 may include one or more interfaces (e.g., MIPI® or embedded display port (eDP)) for coupling to a user display (e.g., a touchscreen or an external display).

I/O bridge 1750 may include various elements configured to implement universal serial bus (USB) communications, security, audio, and low-power always-on functionality, for example. I/O bridge 1750 may also include interfaces such as pulse-width modulation (PWM), general-purpose input/output (GPIO), serial peripheral interface (SPI), and inter-integrated circuit (I2C), for example. Various types of peripherals and devices may be coupled to device 1700 via I/O bridge 1750.

In some embodiments, device 1700 includes network interface circuitry (not explicitly shown), which may be connected to fabric 1710 or I/O bridge 1750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1700 with connectivity to various types of other devices and networks.

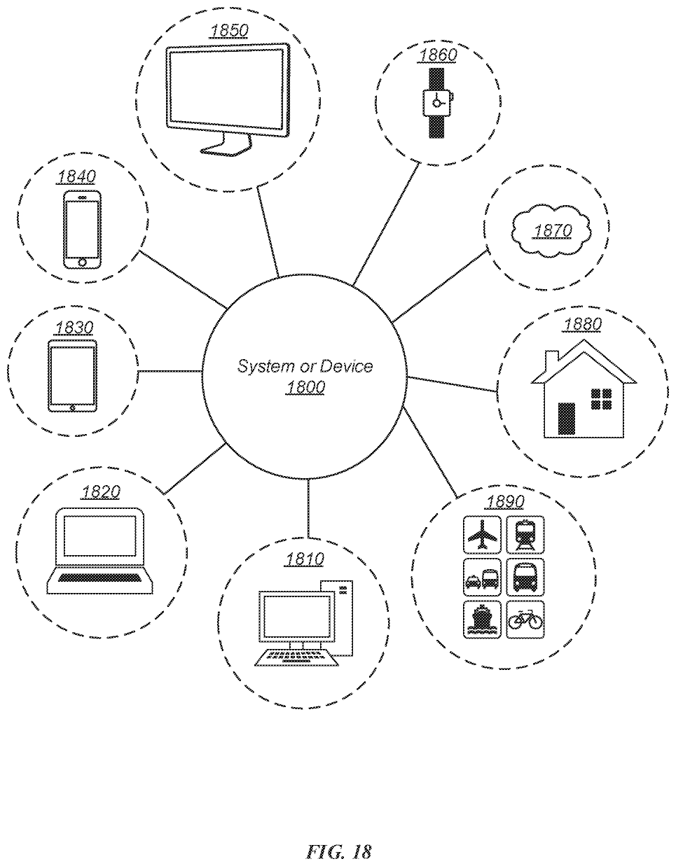

Turning now to FIG. 18, various types of systems that may include any of the circuits, devices, or systems discussed above are illustrated. System or device 1800, which may incorporate or otherwise utilize one or more of the techniques described herein, may be utilized in a wide range of areas. For example, system or device 1800 may be utilized as part of the hardware of systems such as a desktop computer 1810, laptop computer 1820, tablet computer 1830, cellular or mobile phone 1840, or television 1850 (or set-top box coupled to a television).

Similarly, disclosed elements may be utilized in a wearable device 1860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1800 may also be used in various other contexts. For example, system or device 1800 may be utilized in the context of a server computer system, such as a dedicated server or on shared hardware that implements a cloud-based service 1870. Still further, system or device 1800 may be implemented in a wide range of specialized everyday devices, including devices 1880 commonly found in the home such as refrigerators, thermostats, security cameras, etc. The interconnection of such devices is often referred to as the “Internet of Things” (IoT). Elements may also be implemented in various modes of transportation. For example, system or device 1800 could be employed in the control systems, guidance systems, entertainment systems, etc. of various types of vehicles 1890.

The applications illustrated in FIG. 18 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

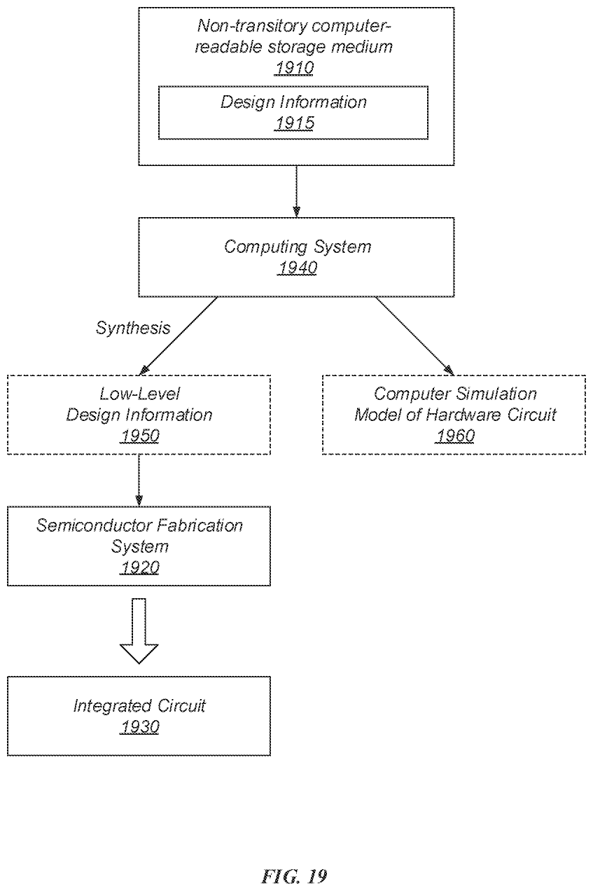

FIG. 19 is a block diagram illustrating an example of a non-transitory computer-readable storage medium that stores design information 1915, according to some embodiments. In the illustrated embodiment, computing system 1940 is configured to process design information 1915. This may include executing instructions included in design information 1915, interpreting instructions included in design information 1915, compiling, transforming, or otherwise updating design information 1915, etc. Therefore, design information 1915 controls computing system 1940 (e.g., by programming computing system 1940) to perform various operations discussed below, in some embodiments.

In the illustrated example, computing system 1940 processes design information 1915 to generate both computer simulation model of hardware circuit 1960 and low-level design information 1950. In other embodiments, computing system 1940 may generate only one of these outputs, may generate other outputs based on design information 1915, or both. Regarding computer simulation model of hardware circuit 1960, computing system 1940 may execute instructions of a hardware description language that includes register transfer level (RTL) code, behavioral code, structural code, or some combination thereof. The simulation model may perform the functionality specified by design information 1915, facilitate verification of the functional correctness of the hardware design, generate power consumption estimates, generate timing estimates, etc.

In the illustrated example, computing system 1940 also processes design information 1915 to generate low-level design information 1950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1950 (potentially among other inputs), semiconductor fabrication system 1920 is configured to fabricate integrated circuit 1930 (which may correspond to functionality of the computer simulation model of hardware circuit 1960). Note that computing system 1940 may generate different simulation models based on design information at various levels of description, including low-level design information 1950, design information 1915, and so on. The data representing low-level design information 1950 and computer simulation model of hardware circuit 1960 may be stored on non-transitory computer-readable storage medium 1910, or on one or more other media.

In some embodiments, low-level design information 1950 controls (e.g., programs) semiconductor fabrication system 1920 to fabricate integrated circuit 1930. Thus, when processed by the fabrication system, the design information may program the fabrication system to fabricate a circuit that includes various circuitry disclosed herein.

Non-transitory computer-readable storage medium 1910 may comprise any of various appropriate types of memory devices or storage devices. Non-transitory computer-readable storage medium 1910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 1910 may include other types of non-transitory memory as well, or combinations thereof. Accordingly, non-transitory computer-readable storage medium 1910 may include two or more memory media, which may reside in different locations—for example, in different computer systems that are connected over a network.

Design information 1915 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1940, semiconductor fabrication system 1920, or both. In some embodiments, design information 1915 may also include one or more cell libraries that specify the synthesis, layout, or both of integrated circuit 1930. In some embodiments, design information 1915 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1930 may, in various embodiments, include one or more custom macrocells, such as memories, analog or mixed-signal circuits, and the like. In such cases, design information 1915 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1920 may also be configured to perform various testing of fabricated circuits for correct operation.

In various embodiments, integrated circuit 1930 and computer simulation model of hardware circuit 1960 are configured to operate according to a circuit design specified by design information 1915, which may include performing any of the functionality described herein. For example, integrated circuit 1930 may include any of various elements shown in FIGS. 1-9. Further, integrated circuit 1930 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1915. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1915 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1950. Low-level design information 1950 may program semiconductor fabrication system 1920 to fabricate integrated circuit 1930.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a plurality of sensors;
a plurality of aggregator circuits coupled to corresponding subsets of the plurality of sensors;
a plurality of clients including a particular client configured to generate a request corresponding to a particular sensor of the plurality of sensors; and
an aggregation processor circuit configured to:
receive the request from the particular client; and
relay the request to a particular aggregator circuit of the plurality of aggregator circuits; and
wherein the particular aggregator circuit is configured to relay the request to a particular sensor included in a particular subset of the plurality of sensors coupled to the aggregator circuit.

2. The apparatus of claim 1, wherein the request has an associated quality-of-service level, and wherein to relay the request to the particular aggregator circuit, the aggregation processor circuit is further configured to:
perform a comparison of the associated quality-of-service level of the request with corresponding quality-of-service levels associated with a plurality of previously received requests;
establish an order for relaying the request and the plurality of previously received requests using a result of the comparison; and
relay the request and the plurality of previously received requests using the order.

3. The apparatus of claim 1, wherein to generate the request, the particular client is further configured to write a message to a particular mailbox register of a plurality of mailbox registers included in the aggregation processor circuit.

4. The apparatus of claim 3, wherein the message includes an address corresponding to a location in a memory circuit shared between the particular client and the aggregation processor circuit, and wherein to receive the request from the particular client, the aggregation processor circuit is further configured to retrieve data indicative of the request from the memory circuit using the address.

5. The apparatus of claim 1, wherein the aggregation processor circuit is further configured to relay the request to the particular aggregator circuit using a first communication protocol, and wherein the particular aggregator circuit is further configured to relay the request to the particular sensor using a second communication protocol different than the first communication protocol.

6. The apparatus of claim 1, wherein the plurality of clients and the aggregation processor circuit are located on a first integrated circuit, and wherein the plurality of aggregator circuits are located on corresponding ones of a plurality of second integrated circuits.

7. A method, comprising:
generating a request by a particular client of a plurality of clients;
receiving the request by an aggregation processor;
relaying, by the aggregation processor, the request to a particular aggregator circuit of a plurality of aggregator circuits, wherein the particular aggregator circuit is coupled to a plurality of sensors; and
relaying, by the particular aggregator circuit, the request to a particular sensor of the plurality of sensors coupled to the particular aggregator circuit.

8. The method of claim 7, wherein relaying, by the aggregation processor, the request to the particular aggregator circuit includes determining an order for relaying the request along with a plurality of previously received requests according to respective quality-of-service levels.

9. The method of claim 8, further comprising initializing respective quality-of-service levels for the plurality of clients as part of a boot operation of a computer system that includes the plurality of clients, the aggregation processor, the plurality of aggregator circuits, and the plurality of sensors.

10. The method of claim 7, wherein generating the request by the particular client of the plurality of clients includes writing, by the particular client, a message into a mailbox register included in the aggregation processor.

11. The method of claim 10, wherein the message includes an address corresponding to a location in a memory circuit shared by the particular client and the aggregation processor, and wherein receiving the request by the aggregation processor includes reading, by the aggregation processor using the address, information indicative of the request from the memory circuit.

12. The method of claim 7, further comprising, relaying, by the aggregation processor, the request to the particular aggregator circuit using a first communication protocol, and relaying, by the particular aggregator circuit, the request to the particular sensor using a second communication protocol different than the first communication protocol.

13. The method of claim 7, wherein the plurality of clients and the aggregator processor are located on a first integrated circuit, and wherein the plurality of aggregator circuits are located on corresponding ones of a plurality of second integrated circuits.

14. A system, comprising:
a system-on-a-chip that includes a plurality of clients;
a plurality of sensors; and
a plurality of aggregator circuits, wherein given aggregator circuits of the plurality of aggregator circuits are coupled to corresponding subsets of the plurality of sensors;
wherein a particular sensor of the plurality of sensors is configured, in response to receiving a request from a particular client, to transmit data to a corresponding aggregator circuit of the plurality of aggregator circuits; and
wherein the corresponding aggregator circuit is configured to relay the data to the system-on-a-chip.

15. The system of claim 14, wherein the system-on-a-chip includes an aggregation processor configured to:
receive the data from the corresponding aggregator circuit;
write the data into a memory circuit shared by the particular client and the aggregation processor; and
send a message to the particular client indicating that the data has been written to the memory circuit.

16. The system of claim 15, wherein the particular client is configured, in response to receiving the message from the aggregation processor, to retrieve the data from the memory circuit.

17. The system of claim 15, wherein the system-on-a-chip is further configured to initialize one or more quality-of-service levels for the aggregation processor during a boot process.

18. The system of claim 17, wherein to initialize the one or more quality-of-service levels for the aggregation processor, the system-on-a-chip is further configured to assign corresponding quality-of-service levels for the plurality of sensors.

19. The system of claim 18, wherein to initialize the one or more quality-of-service levels for the aggregation processor, the system-on-a-chip is further configured to assign corresponding quality-of-service levels for the plurality of clients.

20. The system of claim 18, wherein a different sensor of the plurality of sensors is configured, in response to detecting an interrupt condition, to send an interrupt to a different aggregator circuit coupled to the different sensor, wherein the different aggregator circuit is configured to relay the interrupt to the aggregation processor, and wherein the aggregation processor is further configured to relay the interrupt to a different client of the plurality of clients that corresponds to the different sensor.
